(19) United States
(12) Patent Application Publication
(10) Pub. No.: US 2022/0320510 A1
(43) Pub. Date: Oct. 6, 2022

(54) NEGATIVE ELECTRODE, ELECTROCHEMICAL DEVICE AND ELECTRONIC DEVICE

(71) Applicant: Ningde Amperex Technology Limited, Ningde City (CN)

(72) Inventor: Wei Tao, Ningde (CN)

(73) Assignee: Ningde Amperex Technology Limited, Ningde City (CN)

(21) Appl. No.: 17/703,591

(22) Filed: Mar. 24, 2022

(30) Foreign Application Priority Data
Mar. 25, 2021 (CN) 202110322073.2

(51) Int. Cl. H01M 4/58; H01M 4/36

(52) U.S. Cl. CPC H01M 4/5815; H01M 4/366; H01M 2004/027

(57) ABSTRACT

A negative electrode comprises a negative electrode current collector, a first active material layer, and a second active material layer; wherein the second active material layer is located between the negative electrode current collector and the first active material layer; the first active material layer comprises a first active material and a target compound, the target compound comprises AₓB_{y}, where 0<x≤4, 0<y≤8, A comprises a metal element comprising at least one of the group consisting of Li, Na, Mg, Ca, Zn, and Cs, and B comprises a non-metallic element comprising at least one of the group consisting of N, S, and Si.

### CROSS REFERENCE TO RELATED APPLICATION

This application claims priority to the Chinese Patent Application Ser. No. 202110322073.2, filed on Mar. 25, 2021, the content of which is incorporated herein by reference in its entirety.

### TECHNICAL FIELD

This application relates to the field of electrochemical technology, and particularly, to a negative electrode, an electrochemical device and an electronic device.

### BACKGROUND

In recent years, with the rapid development of electronic products and electric vehicles, there has been higher requirements for electrochemical devices (e.g., lithium ion batteries). During the charging and discharging process of the electrochemical device, lithium ions are prone to precipitate on the surface of the negative electrode, thereby causing safety concerns. In order to solve the above-mentioned problem, mass percentage of the active material in the negative electrode active material layer may be reduced, so as to reduce lithium precipitation on the surface. This would lead to a loss of the overall capacity and a loss of the energy density of the electrode. Although the current techniques for improving the electrochemical device can suppress lithium precipitation to a certain extent, it is unsatisfactory, and further improvements are expected.

### SUMMARY

An embodiment of the present application provides a negative electrode comprising a negative electrode current collector, a first active material layer, and a second active material layer; the second active material layer is located between the negative electrode current collector and the first active material layer; the first active material layer comprises a first active material and a target compound, the target compound comprises AₓB_{y}; wherein 0<x≤4, 0<y≤8, A comprises a metal element including at least one selected from the group consisting of Li, Na, Mg, Ca, Zn, and Cs, and B comprises a non-metallic element comprising at least one selected from the group consisting of N, S, and Si.

In some embodiments, AₓB_{y} is selected from at least one of the group consisting of Li₃N, Li₂S, Na₃N, Na₂S, Ca₃N₂, CaS, Mg₃N₂, and MgS.

In some embodiments, the target compound has a mass percentage of 0.1% to 20%, based on the total mass of the first active material layer and the second active material layer.

In some embodiments, the first active material layer has a thickness of h1, and the second active material layer has a thickness of h2, and 10%≤h1/(h1+h2)≤90%.

In some embodiments, 10%≤h1/(h1+h2)≤50%.

In some embodiments, the first active material has a capacity per gram of c1, and the first active material has an average particle size of d1; the second active material layer comprises a second active material, the second active material has a capacity per gram of c2, and the second active material has an average particle size of d2; and c1×d1≥c2×d2.

In some embodiments, the second active material layer comprises a second active material, and the capacity per gram of the first active material is greater than or equal to the capacity per gram of the second active material.

In some embodiments, the second active material layer comprises a second active material; the average particle size of the first active material is greater than or equal to the average particle size of the second active material.

Some embodiments of the application also provides an electrochemical device, comprising a positive electrode, a separator, and the negative electrode as provided in any one of the application; and the separator is located between the positive electrode and the negative electrode.

Some embodiments of the application also provides an electronic device comprising the electrochemical device as provided in any one of the application.

The negative electrode provided by some embodiments of the application comprises a first active material layer and a second active material layer. The first active material layer comprises a target compound, and the target compound has an ionic conductivity in the order of 10⁻⁴ S/cm to 10⁻² S/cm. The presence of the target compound increases the ionic conductivity of the first active material layer, thereby improving the dynamic performance of the first active material layer, improving polarization, reducing Lithium precipitation, and improving the initial efficiency. Meanwhile, compared with the prior art, this does not reduce mass percentage of the active material in the negative electrode active material layer, and thus does not lose energy density thereof.

### BRIEF DESCRIPTION OF THE DRAWINGS

The above and other features, advantages, and aspects of various embodiments of the present disclosure will become obvious with reference to the following particular implementations in conjunction with the accompanying drawings. Throughout the drawings, the same or similar reference numerals indicate the same or similar elements. It is understood that the drawings are schematic, and members and elements are not necessarily drawn to scale.

FIG. 1 is a schematic diagram of a negative electrode according to an embodiment of the present disclosure.

FIG. 2 is a schematic diagram of another negative electrode according to an embodiment of the present disclosure.

FIG. 3A is a schematic diagram of the relationship between voltage and capacity when discharged at a rate of 0.2 C in Example 1, Comparative Example 1 and Comparative Example 2 of the present disclosure.

FIG. 3B is a schematic diagram of the proportion of constant current charging during the charging process of Example 1, Comparative Example 1 and Comparative Example 2 of the present disclosure under different magnification conditions.

### DETAILED DESCRIPTION

Some embodiments of the present application will be described in more detail below. Although some embodiments of the present application are shown, it is understood that the present application can be implemented in various forms and should not be construed as being limited to some embodiments set forth herein.

To the contrary, these embodiments are provided for a more thorough and complete understanding of this application. It is understood that some embodiments of the present application are only used for exemplary purposes, and are not intended to limit the scope of the present application.

Electrochemical devices, such as lithium-ion batteries, may undergo Lithium precipitation during the cycle. The occurrence of Lithium precipitation leads to reduction in the safety performance of the electrochemical device, thereby causing safety hazards.

Lithium precipitation can be suppressed by a double-layer coating. The upper layer of the double-layer coating employs graphite with fast lithium ion-accepting speed and good dynamic performance, while the lower layer of the double-layer coating employs graphite with a slow lithium ion-accepting speed.

However, the graphite with fast lithium ion-accepting speed and good dynamic performance has a lower capacity, and the use of the two kinds of graphite above for double-layer coating will result in a decrease in energy density. Therefore, a further improvement is expected.

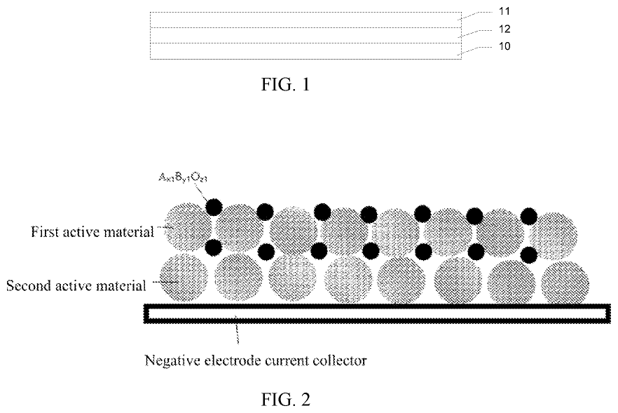

An embodiment of the present application provides a negative electrode, as shown in FIG. 1, comprising: a negative electrode current collector 10, a first active material layer 11, and a second active material layer 12; and the second active material layer 12 is located between the negative electrode current collector 10 and the first active material layer 11.

The negative electrode current collector 10 can be made of copper foil or other materials. In some embodiments, aluminum foil or steel foil can be used as the negative electrode current collector.

The first active material layer 11 comprises a first active material and a target compound. The first active material can be, for example, artificial graphite, natural graphite, coke, silicon-oxygen compound, silicon-containing metal, and the like.

In some embodiments, the first active material has an average particle size of 6 μm to 20 μm. In other embodiments, the second active material has an average particle size of 6 μm to 20 μm. Too large average particle size may result in insufficient rate performance, while too small average particle size may result in degradation of the cycle performance.

In some embodiments of the present disclosure, the first active material layer 11 comprises the target compound. The target compound comprises: AₓB_{y}; where A comprises metal elements, and B comprises non-metal elements. In particular, 0<x≤4, 0<y≤8, and x×the valence state of A=y×the valence state of B. In some embodiments, x and y are positive integers.

In some embodiments, A comprises at least one of the group consisting of Li, Na, Mg, Ca, Zn, and Cs; B comprises at least one of the group consisting of N, S, and Si. The above-mentioned AₓB_{y} has good ionic conductivity and can better improve the dynamic performance of the first active material layer 11. Furthermore, all the ionic radii of the A elements above are no less than those of Li ions, thereby ensuring the Li-ion conductivity. In some embodiments, AₓB_{y} is obtained by decomposition of Aₓ₁B_{y1}O_{z1}, where 0<x1≤4, 0<y1≤4, 0<z1≤8, and x1×the valence state of A=(y1×the valence state of B+z1×the valence state of O). In some embodiments, x and y are positive integers. In some embodiments, Aₓ₁B_{y1}O_{z1} may include at least one of LiNO₃, NaNO₃, Ca(NO₃)₂, Mg(NO₃)₂, Li₂SO₄, or Li₂SiO₃. The dynamic performance of the first active material layer 11 may be significantly improved by adding the compound shown above so as to reduce lithium precipitation and improve charging performance. In some embodiments, AₓB_{y} may be, for example, at least one of the group consisting of Li₃N, Li₂S, Na₃N, Na₂S, Ca₃N₂, CaS, Mg₃N₂, and MgS.

The ionic conductivity of the target compound is in the order of 10⁻⁴ S/cm to 10⁻² S/cm. The presence of the target compound increases the ionic conductivity of the first active material layer 11 and improves the dynamic performance thereof. As such, the first active material layer 11 on one side of the second active material layer 12 away from the negative electrode current collector 10 can conduct ions faster, and hinder ions from accumulating on the surface of the first active material layer 11 through conducting ions into the second active material layer 12, thereby improving the polarization, facilitating to improve the initial efficiency, and without reducing the energy density.

In some embodiments, the decomposition potential of the target compound is greater than or equal to 1.95V. In some embodiments, the target compound needs to remain relatively stable during the cycle of the negative electrode, and it cannot be decomposed because of the cycle process. Therefore, the decomposition potential thereof needs to be greater than or equal to 1.95V.

In some embodiments, the mass of the target compound accounts for 1% to 20% of the total mass of the first active material layer 11 and the second active material layer 12. In some embodiments, when mass percentage of the target compound is too low, the dynamic performance of the first active material layer 11 may not be significantly improved. When mass percentage of the target compound is too high, the performance would not be significantly improved, instead of an increase in cost. For determination of mass percentage of the target compound, the distribution of each element can be tested through a scanning electron microscope or a transmission electron microscope, and mass percentage of the target compound can be determined according to mass percentage of the element.

In some embodiments, mass percentage of the target compound is 0.1% to 20%, based on the total mass of the first active material layer 11 and the second active material layer 12. In some embodiments, when mass percentage of the target compound is too low, the dynamic performance of the first active material layer 11 is not significantly improved, and higher mass percentage of the target compound may result in increased costs. In some embodiments, mass percentage of the target compound based on the total mass of the first active material layer 11 and the second active material layer 12 can be measured by using X-ray photoelectron spectroscopy to measure mass percentage of the target compound in the first active material layer and the second active material layer.

The second active material layer comprises a second active material. The second active material may be at least one of artificial graphite, natural graphite, silicon-oxygen compound, or silicon-containing alloy.

The second active material and the first active material may be the same or different kinds of active materials. The second active material and the first active material may be the same kinds of materials. For example, both of the second active material and the first active material are graphite. The second active material and the first active material may be different kinds of materials, for example, the second active material is graphite and the first active material is silica.

The average particle size of the second active material and the average particle size of the first active material may be the same or different. In this application, when the difference between the average particle size of the second active material and the average particle size of the first active material is not more than 10%, it is believed that the average particle size of the second active material and the average particle size of the first active material are identical. In some embodiments, the average particle size of the second active material can be obtained by measuring the Dv50 of the second active material with a Malvern particle size analyzer, which is the average particle size of the second active material. Similarly, the average particle size of the first active material can be obtained by measuring the Dv50 of the first active material with the Malvern particle size analyzer, which is the average particle size of the first active material. In some embodiments, the average particle size of the first active material and the average particle size of the second active material can be obtained as follows:

(1) A scanning electron microscope is used to scan the cross section of the electrode in the thickness direction to obtain SEM photographs. Specifically, sampling: the electrochemical device to be tested is disassembled, the electrode is taken out and is then soaked in the dimethyl carbonate (DMC) solution for 6 h to remove the residual liquid electrolyte, and the electrode is finally dried in a drying oven. Sample preparation: the dried electrode is cut out a section to be tested with a blade, that is, the section of the active material layer in the thickness direction, the test sample is then glued to the paraffin by the heating plate, and the section to be tested is polished with ion polisher IB-195020 CCP to make the surface smooth, to obtain a SEM test sample. Testing: the SEM photographs of the active material layer of the electrochemical device to be tested are obtained by the scanning electron microscope (SEM) JEOL6390.

(2) In the obtained SEM photographs, the average particle sizes of the first active material and the second active material are determined. Specifically, in the SEM photographs, n (for example, 100) first active material particles are randomly selected, and the particle size of each of the first active material particles is separately determined to obtain n particle sizes. The arithmetic average of n particle sizes is calculated, that is, the average particle size of the first active material. Similarly, the average particle size of the second active material can be calculated through SEM photographs.

In the SEM photographs, the particle size of a single particle (for example, the first active material particle, and the second active material particle) can be determined by the following method: determining the cross-sectional area of the particle, then determining the size of a circle whose area is equal to the cross-sectional area of the particle as the particle size of the particle. In some embodiments, the particle size of the particle of the application can be determined by the following method: determining the length of the longest diagonal of the particle and the length of the shortest diagonal thereof, then determining the arithmetic average of the length of the longest diagonal and the length of the shortest diagonal as the particle size of the particle. In some embodiments, the length of the longest diagonal of the particle is the particle size thereof. In some embodiments, the length of the longest edge of the particle is the particle size thereof. In some embodiments, scanning electron microscopy can be used to scan the cross-section of the particle to determine the cross-sectional area of the particle, the length of the longest diagonal, the length of the shortest diagonal, and/or the longest edge of the particle.

In some embodiments, the average particle size of the first active material is greater than or equal to the average particle size of the second active material. In some embodiments of the application, the average particle size of the first active material is greater than the average particle size of the second active material. At this time, the specific surface area of the first active material is smaller than the specific surface area of the second active material, and the first active material layer 11 has a larger gap. In this way, during the charging process, lithium ions are easier to enter the second active material layer 12 to insert the second active material, thereby delaying the lithium intercalation speed on the surface of the negative electrode, increasing the lithium intercalation speed inside the negative electrode, reducing the risk of the surface Lithium precipitation and improving the kinetic performance.

The capacity per gram of the second active material and the capacity per gram of the first active material may be the same or different. In this application, when the difference between the capacity per gram of the second active material and the capacity per gram of the first active material is not more than 10%, it is believed that the capacity per gram of the second active material and the capacity per gram of the first active material are the same. In some embodiments, the capacity per gram of the second active material and the capacity per gram of the first active material are the same. Further, in some embodiments, the second active material and the first active material are the same kind of materials with the same capacity per gram. For example, the second active material and the first active material are graphite with the same capacity per gram. In some embodiments, the capacity per gram of the second active material and the capacity per gram of the first active material are different. For example, in some embodiments, the capacity per gram of the first active material is greater than or equal to the capacity per gram of the second active material. In some embodiments, since the capacity per gram of the first active material is greater than or equal to the capacity per gram of the second active material, the first active material can accommodate more lithium ions, thereby increasing the capacity of the negative electrode. Furthermore, since the first active material layer comprises the target compound, it can simultaneously suppress polarization and improve the dynamic performance. In some embodiments, the capacity per gram of the first active material and the second active material is 330 mAh/g to 371 mAh/g.

In some embodiments, the capacity per gram of the first active material is c1, and the average particle size of the first active material is d1. The second active material layer comprises the second active material, the capacity per gram of the second active material is c2, and the average particle size of the second active material is d2; and c1×d1≥c2×d2. In some embodiments, when the first active material and the second active material satisfy the above formula, the effect of improving the dynamic performance is better.

In some embodiments, the capacity per gram of the first active material is greater than or equal to the capacity per gram of the second active material. In some embodiments, since the capacity per gram of the first active material is greater than or equal to the capacity per gram of the second active material, the first active material can accommodate more lithium ions, thereby increasing the capacity of the negative electrode. Furthermore, since the first active material layer comprises the target compound, it can simultaneously suppress polarization and improve the dynamic performance. In some embodiments, the capacity per gram of the first active material and the second active material is 330 mAh/g to 371 mAh/g.

The second active material layer 12 is located between the negative electrode current collector 10 and the first active material layer 11.

The first active material layer 11 and the second active material layer 12 on the negative current collector 10 can be coated by a double-layer coating.

In some embodiments, a double-layer coating may be used. First, a slurry of the second active material layer is coated on the negative electrode current collector 10 to form the second active material layer 12, and then a slurry of the first active material layer is coated on the second active material layer 12 to form the first active material layer 11. The additive Aₓ₁B_{y1}O_{z1} is added to the slurry of the first active material layer, and the Aₓ₁B_{y1}O_{z1} sheet is not added to the second active material layer 12. The Aₓ₁B_{y1}O_{z1} may include, for example, at least one of LiNO₃, NaNO₃, Ca(NO₃)₂, Mg(NO₃)₂, Li₂SO₄, or Li₂SiO₃, and it has a decomposition potential of 0.3 to 1.0 V. The Aₓ₁B_{y1}O_{z1} participates in the formation of a SEI (solid electrolyte interphase) membrane with a high ionic conductivity during formation of the electrochemical device, and decomposes to form a SEI film with a high ionic conductivity rich in AₓB_{y}, which is included in the first active material layer. Since the additive Aₓ₁B_{y1}O_{z1} may not be completely decomposed, in some embodiments, the first active material layer 11 of the negative electrode may also comprise Aₓ₁B_{y1}O_{z1}. By forming a SEI film with a high ionic conductivity rich in AₓB_{y} on the first active material layer 11, the dynamic performance of the first active material layer 11 is improved, the polarization of the negative electrode is improved, the Lithium precipitation is reduced, and the charging ability is improved. It is beneficial to improve the initial efficiency of the electrochemical device without causing capacity loss. In addition, because the Aₓ₁B_{y1}O_{z1} is only added to the first active material layer 11 closer to the outside but not added to the second active material layer 12, on the one hand, it ensures that the Aₓ₁B_{y1}O_{z1} can be sufficiently decomposed to form the SEI film, on the other hand, it ensures that the gas produced when the Aₓ₁B_{y1}O_{z1} is decomposed would not cause the cohesive force between the second active material layer 12 and the negative electrode current collector 10 to decrease.

In some embodiments, the first active material layer 11 has a thickness of h1, the second active material layer 12 has a thickness of h2, and 10%≤h1/(h1+h2)≤90%. In some embodiments, when the thickness of the first active material layer 11 is too low relative to the total thickness of the first active material layer 11 and the second active material layer 12, lithium ions may be accumulated in the part of the second active material layer 12 near the first active material layer 11. For this, Lithium ions cannot be inserted into the deeper interior of the second active material layer 12, resulting in the inability to fully utilize the charging capacity of the second active material layer 12. However, when the thickness of the first active material layer 11 is too high relative to the total thickness of the first active material layer 11 and the second active material layer 12, the gas produced during decomposition of the Aₓ₁B_{y1}O_{z1} may affect the cohesive force between the second active material layer 12 and the negative electrode current collector. In some embodiments, 10%≤h1/(h1+h2)≤50%, and when in this range, the performance of the electrochemical device is better. In some embodiments, a scanning electron microscope (SEM) may be used to measure the thickness of the active material layer (for example, the thickness h1 of the first active material layer, or the thickness h2 of the second active material layer). It is understood that, in some embodiments, there is no obvious boundary between the first active material layer and the second active material layer. The thickness of the first active material layer is measured in the following manner: a sample with a predetermined size is taken from the electrode to be tested (the sample size is, for example, 5 cm×1 cm×thickness, where the thickness is thickness of the electrode), and three test points are selected from the SEM photograph in the direction perpendicular to the thickness of the electrode; the thickness of the first active material layer corresponding to these three points is tested respectively, and is recorded as h11, h12, and h13; the average value of h11, h12, and h13 is calculated, that is, the thickness h1 of the first active material layer. Similarly, the thickness h2 of the second active material layer can be measured.

In some embodiments, the first active material layer and the second active material layer may further comprise a conductive agent. The conductive agent may include at least one of conductive carbon black, Ketjen black, lamellar graphite, graphene, carbon nanotubes, or carbon fibers.

In some embodiments, an electrochemical device is also provided, which further comprises: a positive electrode, a separator, and the negative electrode in any one of the embodiments. The separator is provided between the positive electrode and the negative electrode. The positive electrode comprises a positive electrode current collector and a positive electrode active material layer provided on the positive electrode current collector. The positive electrode active material layer is provided on one side or both sides of the positive electrode current collector. In some embodiments, Al foil can be used as the positive electrode current collector. Of course, other positive electrode current collectors commonly used in the art may also be used. In some embodiments, the positive electrode current collector may have a thickness of 1 μm to 200 μm. In some embodiments, the positive electrode active material layer may be coated only on a partial area of the positive electrode current collector. In some embodiments, the positive electrode active material layer may have a thickness of 10 μm to 500 μm. In some embodiments, the positive electrode active material layer may further comprise a conductive agent. In some embodiments, the conductive agent in the positive electrode active material layer may include at least one of conductive carbon black, Ketjen black, lamellar graphite, graphene, carbon nanotubes, or carbon fibers. In some embodiments, the positive electrode active material layer has a positive active material, and the mass ratio of the positive electrode active material, the conductive agent, and the binder in the positive electrode active material layer may be 70 to 98:1 to 15:1 to 15. It is understood that the above description is merely exemplary, and any other suitable material, thickness and mass ratio can be used for the active material layer of the positive electrode.

In some embodiments, the separator includes at least one of polyethylene, polypropylene, polyvinylidene fluoride, polyethylene terephthalate, polyimide, or aramid. For example, polyethylene includes at least one selected from high-density polyethylene, low-density polyethylene, or ultra-high molecular weight polyethylene. Particularly, as for polyethylene and polypropylene, they have a good effect on hindering short circuits, and can improve the stability of the battery through the shutdown effect. In some embodiments, the separator has a thickness within the range of about 5 μm to 500 μm.

In some embodiments, the surface of the separator may also comprise a porous layer, which is provided on at least one surface of the substrate of the separator. The porous layer may be a polymer layer or an inorganic layer, or a layer formed by a mixed polymer and an inorganic substance. For example, the inorganic layer comprises inorganic particles and a binder, and the inorganic particles are selected from at least one of alumina (Al₂O₃), silica (SiO₂), magnesium oxide (MgO), titanium oxide (TiO₂), hafnium dioxide (HfO₂), tin oxide (SnO₂), cerium dioxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide or barium sulfate.

In some embodiments, the pores of the separator have a size in the range of about 0.01 μm to 1 μm. The binder of the porous layer is selected from at least one of polyvinylidene fluoride, vinylidene fluoride-hexafluoropropylene copolymer, polyamide, polyacrylonitrile, polyacrylic ester, polyacrylic acid, polyacrylate, sodium carboxymethyl cellulose, polyvinylpyrrolidone, polyvinyl ether, polymethyl methacrylate, polytetrafluoroethylene, or polyhexafluoropropylene. The porous layer on the surface of the separator can improve the heat resistance, oxidation resistance and electrolyte infiltration performance of the separator, and enhance the adhesion between the separator and the electrode.

FIG. 2 is a schematic diagrams of optional structures of negative electrodes according to some embodiments of the present application, respectively. As shown in FIG. 2, by the means of a double-layer coating, a second active material layer with a second active material is coated on the negative electrode current collector then a first active material layer with a first active material is coated on the second active material layer, in which, the Aₓ₁B_{y1}O_{z1} is added to the first active material layer. After formation, a SEI film with high lithium ion conductivity is formed on the surface of the first active material. Its ingredients comprise the inorganic layer containing AₓB_{y}, thereby reducing the electrochemical reaction polarization and improving the kinetic performance. In some embodiments, a second active material layer with a second active material is coated on the negative electrode current collector then a first active material layer with the first active material is coated on the second active material layer, in which the capacity per gram of the first active material is greater than the capacity per gram of the second active material, and the Aₓ₁B_{y1}O_{z1} is added to the first active material layer. The high-capacity first active material in the first active material layer is beneficial to increase the capacity of the electrochemical device, and because the Aₓ₁B_{y1}O_{z1} is added to the first active material layer, after the electrochemical device is formed, a SEI film with a high ionic conductivity is formed on the first active material layer, the polarization of the first active material layer is improved, thereby improving the dynamic performance. In other embodiments of the present application, a second active material layer with a second active material is coated on the negative electrode current collector and a first active material layer with a first active material is coated on the second active material layer, in which the particle size of the first active material is greater than the particle size of the second active material, and the Aₓ₁B_{y1}O_{z1} is added to the first active material layer. Take a lithium-ion battery as an example, during the charging process, the particles on the surface of the negative electrode will first intercalate ions, which causes the state of charge of the particles on the negative electrode surface to be higher than the state of charge of the particles inside the negative electrode, causing the negative electrode surface to easily precipitate ions. Therefore, in some embodiments of the present application, the particle size of the particles of the first active material is greater than particle size of the particles of the second active material, and the increase of the particle size reduces the reaction area of the first active material and delays the increasing speed of the state of charge of the first active material, thereby suppressing the precipitation of surface ions, and further improving the kinetic performance of the electrochemical device. Moreover, adding the Aₓ₁B_{y1}O_{z1} to the first active material layer enables to facilitate to improve the electrochemical reaction polarization of the surface and further improve the kinetics performance.

It is understood that FIG. 2 shows a schematic diagram of some embodiments of the application, which are intended to enable the skilled person in the art to better understand the technical solutions provided by the application without limiting the scope of the present application. In some embodiments, the actual position of the SEI film is different from the position shown in the figure. For example, the SEI film may not be uniformly formed on the surface of the active material particles. In some embodiments, the SEI film also comprises other substances. In some embodiments, the first active material particles and/or the second active material particles have shapes and distributions different from those shown in the figure.

In some embodiments of the present application, the electrochemical device is a wound lithium-ion battery or a stacked lithium-ion battery.

In some embodiments, the electrochemical device may also comprise an electrolyte. The electrolyte may be one or more of a gel electrolyte, a solid electrolyte, and a liquid electrolyte comprising a lithium salt and a non-aqueous solvent. The lithium salt is selected from one or more of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB or lithium difluoroborate. For example, LiPF₆ is selected for lithium salt because it can give high ionic conductivity and improve cycle characteristics.

The non-aqueous solvent may be a carbonate compound, a carboxylate compound, an ether compound, other organic solvents, or a combination thereof.

The carbonate compound may be a chain carbonate compound, a cyclic carbonate compound, a fluorocarbonate compound, or a combination thereof.

Examples of the chain carbonate compounds are diethyl carbonate (DEC), dimethyl carbonate (DMC), dipropyl carbonate (DPC), methyl propyl carbonate (MPC), ethylene propyl carbonate (EPC), methyl ethyl carbonate (MEC) and combinations thereof. Examples of the cyclic carbonate compounds are ethylene carbonate (EC), propylene carbonate (PC), butylene carbonate (BC), vinyl ethylene carbonate (VEC), or a combination thereof. Examples of the fluorocarbonate compounds are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

Examples of the carboxylate compounds are methyl acetate, ethyl acetate, N-propyl acetate, tert-butyl acetate, methyl propionate, ethyl propionate, propyl propionate, γ-butyrolactone, decanolide, valerolactone, mevalonolactone, caprolactone, methyl formate, or a combination thereof.

Examples of the ether compounds are dibutyl ether, tetraglyme, diglyme, 1,2-dimethoxyethane, 1,2-diethoxyethane, ethoxymethoxy ethane, 2-methyltetrahydrofuran, tetrahydrofuran, or a combination thereof.

Examples of the other organic solvents include dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, or phosphate esters, or combinations thereof. Exemplary phosphate esters may include trimethyl phosphate, triethyl phosphate, or trioctyl phosphate, or any combination thereof.

The embodiments of the present application also provide an electronic device including the above-mentioned electrochemical device. The electronic device of some embodiments of the application is not particularly limited, and it can be used in any electronic device known in the prior art. In some embodiments, electronic devices may include, but are not limited to, notebook computers, pen-input computers, mobile computers, e-book players, portable phones, portable fax machines, portable photocopiers, portable printers, headsets, Video recorders, LCD TVs, portable cleaners, portable CD players, MiniDiscs, transceivers, electronic notebooks, calculators, memory cards, portable recorders, radios, backup power supplies, motors, automobiles, motorcycles, assisted bicycles, bicycles, lighting appliance, toys, game consoles, clocks and watches, power tools, flashlights, cameras and large household storage batteries, etc.

Some specific examples and comparative examples are listed below to better explain the present application, in which a lithium-ion battery is used as an example. In order to facilitate description of the technical effects of the present application, the difference between the various examples and the comparative example is only that the negative electrode is different. The following examples are only used for schematic illustration, and should not limit the scope of the present application.

### EXAMPLES

### Example 1

Preparation of the Positive Electrode

The positive electrode active material lithium cobaltate (LiCoO₂), Super P (conductive carbon), and polyvinylidene fluoride were mixed at a mass ratio of 97:1.4:1.6 to obtain a mixture. The N-methylpyrrolidone (NMP) was added to the mixture, which was stirred under the action of a vacuum mixer until the system became uniform so as to obtain the positive electrode slurry, in which the solid content of the positive electrode slurry was 72 wt %. The positive electrode slurry was evenly coated on the positive electrode current collector aluminum foil; and the aluminum foil was dried at 85° C., then after cold pressing, cutting and slitting, it was dried under the vacuum condition of 85° C. for 4 h so as to obtain a positive electrode.

(2) Preparation of the Negative Electrode

The artificial graphite, Super P, sodium carboxymethyl cellulose, and styrene-butadiene rubber were mixed to obtain a mixture. The mixture was added deionized water to obtain a slurry of the second active material layer under the action of a vacuum mixer. The slurry of the second active material layer was uniformly coated on the negative electrode current collector copper foil to form a second active material layer.

The artificial graphite, LiNO₃, Super P, sodium carboxymethyl cellulose, and styrene-butadiene rubber were mixed to obtain a mixture, in which LiNO₃ accounts for 1% of the total mass of the obtained mixture. The mixture was added deionized water to obtain a slurry of the first active material layer under the action of a vacuum mixer. The slurry of the first active material layer was coated on one side of the second active material layer away from the negative electrode current collector to form the first active material layer, dried at 85° C., then subjected to cold pressing, cutting and slitting, further dried under the vacuum condition of 120° C. for 12 h, so as to obtain a negative electrode, in which, the artificial graphite for the first active material layer and the second active material layer was the same type of graphite, and the thickness of the first active material layer and the thickness of the second active material layer account for 50% and 50% of the total thickness of the first active material layer and the second active material layer, respectively.

(3) Preparation of the Liquid Electrolyte

Ethylene carbonate (EC), ethyl methyl carbonate (EMC), and diethyl carbonate (DEC) were mixed at a volume ratio of 1:1:1 in a glove box under an atmosphere of dry argon to obtain an organic solvent. The fully dried lithium salt LiPF₆ was then dissolved in the mixed organic solvent to prepare an liquid electrolyte with a concentration of 1 mol/L.

(4) Preparation of the Separator

The separator of polyethylene (PE) was selected, and was coated with a ceramic layer and a bonding layer.

(5) Preparation of the Lithium-Ion Battery

The positive electrode, the separator, and the negative electrode were stacked in this order to produce a laminate, in which the separator was allowed to locate between the positive electrode and the negative electrode for isolation. The laminate was then wound to obtain the electrode assembly. The Al tab was used as the positive tab, the Ni tab as the negative tab, and the tab was positioned in the middle of the electrodes to reduce ohmic polarization. The electrode assembly was placed in the outer packaging foil aluminum plastic film after welding the tabs to the assembly. The prepared liquid electrolyte was injected into the dried electrode assembly, and the lithium-ion battery was obtained after the steps of vacuum packaging, standing, forming, shaping, and capacity testing.

Each of examples and comparative examples is based on the steps of Example 1 to change the parameters of the negative electrode preparation, and the parameters are modified specifically as follows. Compared with Example 1, in Examples 2 to 25, the content of the additive changes, and the corresponding change is the content of the active material (the content of the artificial graphite). The mass percentage content of Super P, sodium carboxymethyl cellulose, and styrene-butadiene rubber as a whole in the active material layer remains unchanged.

In Example 2, LiNO₃ accounted for 2% of the total mass of the mixed mixture.

The difference between Example 2 and Example 1 is that LiNO₃ accounted for 2% of the total mass of the mixed mixture.

The difference between Example 3 and Example 1 is that LiNO₃ accounted for 4% of the total mass of the mixed mixture.

The difference between Example 4 and Example 1 is that LiNO₃ accounted for 7% of the total mass of the mixed mixture.

The difference between Example 5 and Example 1 is that LiNO₃ accounted for 10% of the total mass of the mixed mixture.

The difference between Example 6 and Example 1 is that LiNO₃ accounted for 15% of the total mass of the mixed mixture.

The difference between Example 7 and Example 1 is that LiNO₃ accounted for 20% of the total mass of the mixed mixture.

The difference between Example 8 and Example 1 is that NaNO₃ was used instead of LiNO₃, and NaNO₃ accounted for 1% of the total mass of the mixed mixture.

The difference between Example 9 and Example 1 is that NaNO₃ was used instead of LiNO₃, and NaNO₃ accounted for 2% of the total mass of the mixed mixture.

The difference between Example 10 and Example 1 is that NaNO₃ was used instead of LiNO₃, and NaNO₃ accounted for 4% of the total mass of the mixed mixture.

The difference between Example 11 and Example 1 is that NaNO₃ was used instead of LiNO₃, and NaNO₃ accounted for 7% of the total mass of the mixed mixture.

The difference between Example 12 and Example 1 is that NaNO₃ was used instead of LiNO₃, and NaNO₃ accounted for 10% of the total mass of the mixed mixture.

The difference between Example 13 and Example 1 is that NaNO₃ was used instead of LiNO₃, and NaNO₃ accounted for 15% of the total mass of the mixed mixture.

The difference between Example 14 and Example 1 is that NaNO₃ was used instead of LiNO₃, and NaNO₃ accounted for 20% of the total mass of the mixed mixture.

The difference between Example 15 and Example 1 is that Mg(NO₃)₂ was used instead of LiNO₃, and Mg(NO₃)₂ accounted for 1% of the total mass of the mixed mixture.

The difference between Example 16 and Example 1 is that Mg(NO₃)₂ was used instead of LiNO₃, and Mg(NO₃)₂ accounted for 2% of the total mass of the mixed mixture.

The difference between Example 17 and Example 1 is that Mg(NO₃)₂ was used instead of LiNO₃, and Mg(NO₃)₂ accounted for 4% of the total mass of the mixed mixture.

The difference between Example 18 and Example 1 is that Mg(NO₃)₂ was used instead of LiNO₃, and Mg(NO₃)₂ accounted for 7% of the total mass of the mixed mixture.

The difference between Example 19 and Example 1 is that Mg(NO₃)₂ was used instead of LiNO₃, and Mg(NO₃)₂ accounted for 10% of the total mass of the mixed mixture.

The difference between Example 20 and Example 1 is that Mg(NO₃)₂ was used instead of LiNO₃, and Mg(NO₃)₂ accounted for 15% of the total mass of the mixed mixture.

The difference between Example 21 and Example 1 is that Mg(NO₃)₂ was used instead of LiNO₃, and Mg(NO₃)₂ accounted for 20% of the total mass of the mixed mixture.

The difference between Example 22 and Example 1 is that the first active material layer and the second active material layer employed different types of the artificial graphite. The capacity per gram of the artificial graphite for the first active material layer×the average particle size of the artificial graphite for the first active material layer ≥the capacity per gram of the artificial graphite for the second active material layer×the average particle size of the artificial graphite for the second active material layer. LiNO₃ was replaced with Mg(NO₃)₂, and Mg(NO₃)₂ accounted for 20% of the total mass of the mixed mixture.

The difference between Example 23 and Example 1 is that the first active material layer and the second active material layer employed different types of the artificial graphite. The capacity per gram of the artificial graphite for the first active material layer×the average particle size of the artificial graphite for the first active material layer ≥the capacity per gram of the artificial graphite for the second active material layer×the average particle size of the artificial graphite for the second active material layer. LiNO₃ accounted for 5% of the total mass of the mixed mixture, and the thickness of the first active material layer and the thickness of the second active material layer accounted for 40% and 60% of the total thickness of the first active material layer and the second active material layer, respectively.

The difference between Example 24 and Example 1 is that the first active material layer and the second active material layer employed different types of the artificial graphite. The capacity per gram of the artificial graphite for the first active material layer×the average particle size of the artificial graphite for the first active material layer ≥the capacity per gram of the artificial graphite for the second active material layer×the average particle size of the artificial graphite for the second active material layer. LiNO₃ accounted for 5% of the total mass of the mixed mixture, and the thickness of the first active material layer and the thickness of the second active material layer accounted for 30% and 70% of the total thickness of the first active material layer and the second active material layer, respectively.

The difference between Example 25 and Example 1 is that the first active material layer and the second active material layer employed different types of the artificial graphite. The capacity per gram of the artificial graphite for the first active material layer×the average particle size of the artificial graphite for the first active material layer ≥the capacity per gram of the artificial graphite for the second active material layer×the average particle size of the artificial graphite for the second active material layer. LiNO₃ accounted for 5% of the total mass of the mixed mixture, and the thickness of the first active material layer and the thickness of the second active material layer accounted for 20% and 80% of the total thickness of the first active material layer and the second active material layer, respectively.

The difference between Comparative Example 1 and Example 1 is that in Comparative Example 1, only the second active material layer was coated on the copper foil and the first active material layer was not coated.

The difference between Comparative Example 2 and Example 1 is that in Comparative Example 2, only the first active material layer was coated on the copper foil and the second active material layer was not coated.

The difference between Comparative Example 3 and Example 1 is that the artificial graphite in the first active material layer and that in the second active material layer in Comparative Example 3 were different types of the artificial graphite, LiNO₃ was not added to the first active material layer, and the capacity per gram of the artificial graphite for the first active material layer×the average particle size of the artificial graphite for the first active material layer ≥the capacity per gram of the artificial graphite for the second active material layer×the average particle size of the artificial graphite for the second active material layer.

The testing methods of various parameters of the application are described below.

Initial Efficiency Test:

The lithium-ion battery was formed through the first cycle of charging. Thereafter, the capacity released in the first cycle/the power charged in the first cycle was the initial efficiency. The specific parameters of the formation were as follows: the battery was heated to 60° C., and was charged at the rate of 0.5 C (2 h full charge) for 100 min, and then was cooled down by 25° C.

Cycle Test:

The formed lithium-ion battery was charged to 4.2V at a constant current of 3 C at 25° C., and then was charged to a current of 0.05 C at a constant voltage. After standing for 5 min, the battery was discharged to 2.8V at 1 C. As such, the charge-discharge cycle was conducted 1000 cycles. The discharge capacity of the first cycle was recorded as D0, and the discharge capacity of the 1000^{th} cycle as D1;

Capacity retention rate of 1000 cycles(%)=D1/D0×100%.

3 C Constant Current Charging Ratio at 25° C.:

The lithium-ion battery was charged to 4.2V at a constant current of 3 C at 25° C., and then was charged at a constant voltage to a current of 0.05 C. During the charging process, the ratio of the constant current charging power to the total charging power is the 3 C constant current charging ratio at 25° C., which was used to characterize the polarization. The smaller the polarization of the lithium-ion battery, the higher the corresponding 3 C constant current charge ratio at 25° C.

The performance test results of lithium-ion batteries in Examples 1 to 25 and Comparative Examples 1 to 3 were shown in Table 1.

TABLE 1

| | Initial | Capacity retention | 3 C constant current |
|---|---|---|---|
| Items | efficiency | rate of 1000 cycles | charge ratio at 25° C. |
| Ex. 1 | 91.4% | 82.5% | 65.6% |
| Ex. 2 | 91.5% | 83.6% | 66.7% |
| Ex. 3 | 91.6% | 83.1% | 66.8% |
| Ex. 4 | 91.8% | 82.7% | 66.8% |
| Ex. 5 | 92% | 84.1% | 67.5% |
| Ex. 6 | 92.2% | 83.2% | 67.2% |
| Ex. 7 | 93.1% | 82.6% | 67.1% |
| Ex. 8 | 90.5% | 82.7% | 65.1% |
| Ex. 9 | 90.7% | 83.4% | 65.2% |
| Ex. 10 | 90.8% | 83.2% | 62.4% |
| Ex. 11 | 90.9% | 82.4% | 64.7% |
| Ex. 12 | 91.2% | 83.6% | 64.6% |
| Ex. 13 | 91.3% | 83.3% | 65.2% |
| Ex. 14 | 91.7% | 82.4% | 66.1% |
| Ex. 15 | 91.2% | 81.6% | 66.3% |
| Ex. 16 | 91.4% | 83.5% | 62.5% |
| Ex. 17 | 91.6% | 84.1% | 61.7% |
| Ex. 18 | 91.7% | 82.6% | 60.6% |
| Ex. 19 | 91.8% | 82.5% | 62.4% |
| Ex. 20 | 92.1% | 83.7% | 63.5% |
| Ex. 21 | 92.3% | 84.7% | 64.2% |
| Ex. 22 | 93.6% | 85.7% | 67% |
| Ex. 23 | 92.8% | 84.7% | 69.2% |
| Ex. 24 | 92.6% | 86.7% | 68.2% |
| Ex. 25 | 92.1% | 86.3% | 68.9% |
| Com. Ex. 1 | 88% | 76% | 54.6% |
| Com. Ex. 2 | 65% | 54% | 66.3% |
| Com. Ex. 3 | 68% | 82% | 64.2% |

Comparing Examples 1 to 25 with Comparative Examples 1 to 3, it can be seen that the initial efficiency, the capacity retention rate of 1000 cycles, and the 3 C constant current charging ratio at 25° C. in Examples 1 to 25 are all higher than those in Comparative Examples 1 to 3. This is because the double-layer coating is not used in Comparative Example 1, and no additives such as LiNO₃ are added. The additives are substances that can decompose and generate target compounds after the electrochemical device is charged and discharged. Therefore, lithium ions are readily accumulated on the surface of the negative electrode, leading to Lithium precipitation, loss of capacity, lower initial efficiency, deterioration of the kinetic performance, and lowering the cycle performance. Although LiNO₃ is added in Comparative Example 2, the double-layer coating is not used. While it can improve the kinetic performance to a certain extent, the gas production during decomposition of LiNO₃ leads to a decrease in the cohesive force between the active material layer and the negative electrode. Moreover, because LiNO₃ is distributed on the surface and inside of the active material layer, the internal LiNO₃ is not sufficiently decomposed and the overall LiNO₃ is decomposed unevenly. These factors cause the initial efficiency loss and the cycle performance degradation. In Comparative Example 3, compounds such as LiNO₃ are not added, and thus Lithium precipitation is easy to occur, resulting in insufficient initial efficiency, cycle performance and kinetic performance. In Examples 1 to 25, double-layer coating is used, Aₓ₁B_{y1}O_{z1} is added to the raw material of the first active material layer, and the first active material layer is located on the upper layer of the second active material layer. Therefore, Aₓ₁B_{y1}O_{z1} can be fully decomposed, through which AₓB_{y} with a high ionic conductivity is formed. The ionic conductivity of AₓB_{y} is higher than 10⁻³ mS cm⁻¹, thereby increasing the ionic conductivity of the first active material layer. Therefore, compared with the case where the first active material layer is without AxBy, the lithium ions can faster transport into the second active material layer inside the negative electrode through the first active material layer, thereby hindering the lithium ions from accumulating on the first active material layer and suppressing the Lithium precipitation, and improving the dynamic performance of the first active material layer and the cycle performance. In addition, since Aₓ₁B_{y1}O_{z1} is added to the raw material of the first active material layer, gas is produced when Aₓ₁B_{y1}O_{z1} is decomposed, which increases the porosity of the first active material layer and further improves the dynamic performance of the first active material layer. Moreover, the first active material layer is on the second active material layer and is away from the current collector. The second active material layer does not comprise Aₓ₁B_{y1}O_{z1}. Accordingly, after decomposition of Aₓ₁B_{y1}O_{z1}, the adhesion between the second active material layer and the current collector will be maintained. Therefore, some embodiments of the present application define that the negative electrode comprises a first active material layer and a second active material layer, and the first active material layer comprises AₓB_{y}.

By comparing Examples 1 to 7, it can be seen that as the amount of LiNO₃ added to the raw material of the first active material layer increases, the initial efficiency of the lithium-ion battery gradually increases, the capacity retention rate of 1000 cycles fluctuates within a certain range, and the 3 C constant current charging ratio at 25° C. first increases and then slightly decreases. This may be because with an increase in the amount of LiNO₃ added, the ionic conductivity of the first active material layer gradually increases, and thus it is beneficial to improve the initial efficiency and reduce the polarization. The addition of LiNO₃ enables to improve the cycle performance. However, when the addition amount reaches a certain level, the change in the addition amount has no obvious effect on the cycle performance. Examples 8 to 14 and Examples 15 to 21 show similar characteristics. It can be seen that addition of different types of AₓB_{y} enables to achieve the improvement effect.

By comparing Example 21 and Example 22, it can be seen that the initial efficiency, the cycle performance of 1000 cycles, and the 3 C constant current charging ratio at 25° C. in Example 22 are better than those in Example 21. Therefore, when the capacity per gram c1 of the first active material, the average particle size d1 of the first active material; the capacity per gram c2 of the second active material and the average particle size d2 of the second active material satisfy c1×d1≥c2×d2, the initial efficiency and cycle performance of the lithium-ion battery can be further improved and polarization is suppressed. When the capacity per gram of the first active material and the capacity per gram of the second active material are equal, the particle size of the first active material is larger than the particle size of the second active material. The larger particles being on the upper layer can reduce the tortuosity of the upper pore channels, thereby increasing the migration speed of the lithium ions and reducing the unevenness of lithium insertion in the direction of the electrode. And if the particle size of the first active material and the particle size of the second active material are similar (for example, equal), since the capacity per gram of the first active material is larger, more lithium can be inserted, and the descent speed of the real potential during the constant current charging slows down, so that the lithium precipitation is not easy to occur on the upper layer, thereby improving the cycle performance and suppressing polarization.

By comparing Examples 23 to 25, it can be seen that as the ratio of the thickness of the first active material layer to the total thickness of the first active material layer and the second active material layer gradually decreases, the initial efficiency of the lithium-ion battery gradually decreases, and the cycle performance and the 3 C constant current charge ratio at 25° C. fluctuate within a certain range, and the overall performance of the lithium-ion battery still remains within a good range. It can be seen that when the ratio of the thickness of the first active material layer to the total thickness of the first active material layer and the second active material layer is within the range of 20% to 50%, better performance can be maintained.

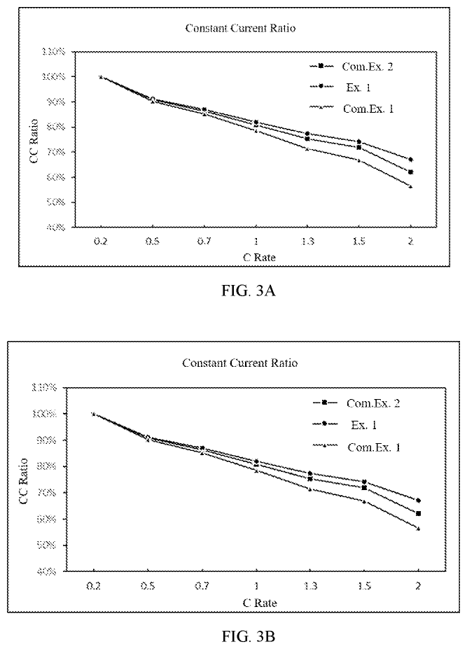

FIG. 3A is a schematic diagram of the relationship between voltage and capacity when discharged at a rate of 0.2 C in Example 1, Comparative Example 1 and Comparative Example 2 of the present disclosure. FIG. 3B is a schematic diagram of the constant current charging ratio (CC ratio) during the charging process under different magnifications in Example 1, Comparative Example 1 and Comparative Example 2 of the present disclosure. As shown in FIG. 3A, the capacity of the lithium-ion battery in Example 1 of the present application is greater than that in Comparative Example 1 and Comparative Example 2. It can be seen from FIG. 3B that the constant current charging ratios under different magnifications in Example 1 are all higher than those in Comparative Example 1 and Comparative Example 2. This is because in Example 1 of the present application, the first active material layer and the second active material layer are prepared by the double-layer coating, and the Aₓ₁B_{y1}O_{z1} additive is added to the first active material layer. The AₓB_{y} generated after decomposition of the additive improves the dynamic performance without reducing the cohesive force between the second active material layer and the negative electrode current collector. The improvement of the dynamic performance improves the charge-discharge performance. Lithium ions can be better inserted into the negative electrode, so the constant current charging ratio is increased, and the time required for charging is reduced. Due to improvement of the kinetic performance, the polarization and the Lithium precipitation are reduced, and the capacity loss by the Lithium precipitation is suppressed.

Although the present subject matter has been described in a language specific to structural features and/or logical actions of the method, it is understood that the subject matter defined in the appended claims is not necessarily limited to the particular features or actions described above. To the contrary, the particular features and actions described above are merely exemplary forms of implementing the claims.

What is claimed is:

1. A negative electrode, comprising:
a negative electrode current collector, a first active material layer, and a second active material layer;
wherein
the second active material layer is located between the negative electrode current collector and the first active material layer;
the first active material layer comprises a first active material and a target compound, the target compound comprising AₓB_{y}, wherein
0<x≤4, 0<y≤8;
A comprises a metal element comprising at least one selected from the group consisting of Li, Na, Mg, Ca, Zn, and Cs; and
B comprises a non-metallic element comprising at least one selected from the group consisting of N, S, and Si.

2. The negative electrode of claim 1, wherein AₓB_{y} is at least one selected from the group consisting of Li₃N, Li₂S, Na₃N, Na₂S, Ca₃N₂, CaS, Mg₃N₂, and MgS.

3. The negative electrode of claim 1, wherein the target compound has a mass percentage of 0.1% to 20%, based on a total mass of the first active material layer and the second active material layer.

4. The negative electrode of claim 1, wherein the first active material layer has a thickness of h1, and the second active material layer has a thickness of h2, and wherein
10%≤h1/(h1+h2)≤90%.

5. The negative electrode of claim 4, wherein 10%≤h1/(h1+h2)≤50%.

6. The negative electrode of claim 1, wherein,
the first active material has a capacity per gram of c1;
the first active material has an average particle size of d1;
the second active material layer comprises a second active material;
the second active material has a capacity per gram of c2; and
the second active material has an average particle size of d2; and
wherein c1×d1≥c2×d2.

7. The negative electrode of claim 6, wherein 6 μm≤c1≤20 μm.

8. The negative electrode of claim 1, wherein the second active material layer comprises a second active material, and a capacity per gram of the first active material is greater than or equal to a capacity per gram of the second active material.

9. The negative electrode of claim 1, wherein the second active material layer comprises a second active material; and an average particle size of the first active material is greater than or equal to an average particle size of the second active material.

10. An electrochemical device, comprising:
a positive electrode;
a negative electrode; and
a separator located between the positive electrode and the negative electrode;
wherein the negative electrode comprises:
a negative electrode current collector, a first active material layer, and a second active material layer, and wherein
the second active material layer is located between the negative electrode current collector and the first active material layer;
the first active material layer comprises a first active material and a target compound, the target compound comprising: AₓB_{y},
wherein 0<x≤4, 0<y≤8;
A comprises a metal element comprising at least one selected from the group consisting of Li, Na, Mg, Ca, Zn, and Cs; and
B comprises a non-metallic element comprising at least one selected from the group consisting of N, S, and Si.

11. The electrochemical device of claim 10, wherein AₓB_{y} is at least one selected from the group consisting of Li₃N, Li₂S, Na₃N, Na₂S, Ca₃N₂, CaS, Mg₃N₂, and MgS.

12. The electrochemical device of claim 10, wherein the target compound has a mass percentage of 0.1% to 20%, based on a total mass of the first active material layer and the second active material layer.

13. The electrochemical device of claim 10, wherein the first active material layer has a thickness of h1, and the second active material layer has a thickness of h2, and
10%≤h1/(h1+h2)≤90%.

14. The electrochemical device of claim 13, wherein 10%≤h1/(h1+h2)≤50%.

15. The electrochemical device of claim 10, wherein,
the first active material has a capacity per gram of c1;
the first active material has an average particle size of d1;
the second active material layer comprises a second active material;
the second active material has a capacity per gram of c2; and
the second active material has an average particle size of d2; and
wherein c1×d1≥c2×d2.

16. The electrochemical device of claim 15, wherein 6 μm≤c1≤20 μm.

17. The electrochemical device of claim 10, wherein the second active material layer comprises a second active material, and a capacity per gram of the first active material is greater than or equal to a capacity per gram of the second active material.

18. The electrochemical device of claim 10, wherein the second active material layer comprises a second active material; and an average particle size of the first active material is greater than or equal to an average particle size of the second active material.

19. An electronic device comprising an electrochemical device comprising a positive electrode, a negative electrode, and a separator located between the positive electrode and the negative electrode, the negative electrode comprising:
a negative electrode current collector, a first active material layer, and a second active material layer,
wherein
the second active material layer is located between the negative electrode current collector and the first active material layer;
the first active material layer comprises a first active material and a target compound, the target compound comprising: AₓB_{y},
wherein
0<x≤4, 0<y≤8,
A comprises a metal element comprising at least one selected from the group consisting of Li, Na, Mg, Ca, Zn, and Cs, and
B comprises a non-metallic element comprising at least one selected from the group consisting of N, S, and Si.
